(19) United States
(12) Patent Application Publication
(10) Pub. No.: US 2016/0248287 A1
(43) Pub. Date: Aug. 25, 2016

(54) COMPRESSOR

(71) Applicant: GEA REFRIGERATION GERMANY GMBH, Berlin (DE)

(72) Inventor: Wolfgang SANDKÖTTER, Berlin (DE)

(21) Appl. No.: 15/029,857

(22) PCT Filed: Oct. 16, 2014
(86) PCT No.: PCT/EP2014/002787

§ 371 Date: Apr. 15, 2016

(30) Foreign Application Priority Data
Oct. 16, 2013 (DE) 10 2013 017 147.4

(51) Int. Cl. H02K 3/02; H02K 15/04; F04B 25/00; F04C 29/04; F04C 18/16; F04C 29/00; F04B 53/08; H02K 3/44; F04B 35/04

(52) U.S. Cl. CPC H02K 3/02; H02K 3/44; H02K 15/04; F04B 25/005; F04B 35/04; F04C 18/16; F04C 29/0085; F04B 53/08; F04C 29/04

(57) ABSTRACT

A compressor (10), in particular a semi-hermetic or hermetic positive-displacement compressor for compressing NH₃, said compressor having an at least partially NH₃-cooled electric motor (12) comprising motor windings (24). The motor windings (24) have a conductor (26) made of copper and an ammonia-resistant coating (28). A method for producing a corresponding compressor.

The present invention relates to a compressor according to the preamble of claim 1, and to a method for producing a compressor, according to claim 5.

Displacement compressors for compressing NH₃ are used in many areas of daily life and are nowadays the subject of increased interest due to the desired reduced use of halogenated hydrocarbons as coolant, which have been under debate in particular on account of their relatively high global warming potential.

Compressors of different constructions are available in order to be able to satisfactorily fulfill a respective use-specific object. Examples which may be named at this point are reciprocating piston compressors or screw compressors.

In the field of reciprocating piston compressors and also that of screw compressors, there exist semi-hermetic and hermetic embodiments having an electric motor which is at least partially NH₃-cooled. That is to say that the electric motor of the NH₃ compressor in a refrigeration plant is at least partially cooled using NH₃, cooling generally being carried out using intake gas, i.e. expanded NH₃ which is to be compressed or, in the case of two-stage compressors, also using intermediate-pressure gas, that is to say intake gas for a second compressor stage.

Due to the corrosive action of NH₃, the motor windings of prior art NH₃ compressors are made of aluminum. As the conductivity of aluminum is relatively bad, this requires a relatively large cross-section for the windings. This increases the size of the motor and also that of the pressure-resistant motor housing, leading to high weight of the corresponding compressor. Moreover, in spite of the larger construction size, the efficiencies of aluminum windings remain below those of motors having windings made of more conductive materials.

Starting from this point, the present invention has the object of specifying a compressor, in particular a semi-hermetic or hermetic displacement compressor, for compressing NH₃, which is as lightweight, as compact and as efficient as possible compared to the prior art compressors. The present invention also has the object of specifying a corresponding method for producing such a compressor.

This object is achieved, according to the invention, with a compressor according to claim 1 and, with respect to the method aspect, with a method having the features of claim 5.

The object is achieved in terms of apparatus with a compressor, in particular a semi-hermetic or hermetic displacement compressor, for compressing NH₃, having an at least partially NH₃-cooled electric motor with motor windings, wherein the motor windings are made of copper and have an ammonia-resistant coating. The coating is optionally made of an extrudable material, or is extruded. The motor windings and the coating can be co-extruded, which ensures cost-effective and simple production.

It is to be noted, at this point, that a compressor according to the invention can be created in many different constructions, in particular as a semi-hermetic or hermetic NH₃ compressor with intake gas cooling or intermediate pressure cooling, moreover in particular as a semi-hermetic or hermetic screw compressor, as a semi-hermetic or hermetic compact screw compressor, or as a semi-hermetic or hermetic single-stage or two-stage piston compressor.

Furthermore, the concept of the present invention includes a corresponding method for producing a compressor, in particular a semi-hermetic or hermetic displacement compressor, for compressing NH₃, having an at least partially NH₃-cooled electric motor with motor windings, wherein the method has a step of producing the motor windings. The step of producing the motor windings has the following sub-steps:
manufacturing the motor windings from the copper material;
coating the motor windings with an ammonia-resistant material.

In possible embodiments, both the motor windings and/or the ammonia-resistant coating can be produced by means of an extrusion method, it being also conceivable that the motor windings and the coating are extruded in immediate succession, wherein in this case the above-mentioned sub-steps are carried out in immediate succession. The ammonia-resistant coating can furthermore (optionally) be sprayed on or applied by means of a dipping method.

Furthermore, the basic concept of the present invention includes a corresponding use of motor windings which are made of copper and have an ammonia-resistant coating, for the production of an electric motor of a compressor, in particular a semi-hermetic or hermetic displacement compressor, for compressing NH₃, having an at least partially NH₃-cooled electric motor with motor windings. The motor windings and/or the coating can, in one possible embodiment, be extruded. Optionally, the motor windings and the coating can also be formed in two immediately successive extrusion steps, or the ammonia-resistant coating can be sprayed on or applied by means of a dipping method.

Further optional features of the invention are indicated in the subclaims and in the following description of the figures. The described respective features can be realized individually or in any combination. Accordingly, the invention is described in the following in relation to the appended drawings and with reference to exemplary embodiments. In the drawings:

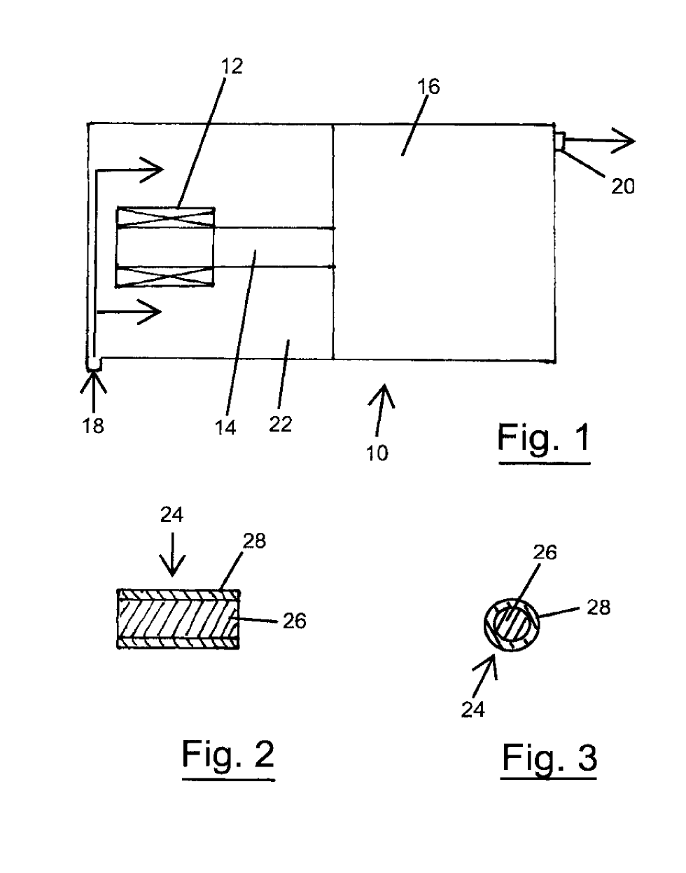

FIG. 1 shows a schematic representation of an exemplary embodiment of a compressor according to the invention;

FIG. 2 shows a view of a motor winding of the compressor from FIG. 1 in longitudinal section; and

FIG. 3 shows a view of a motor winding of the compressor from FIG. 1 in cross section.

FIG. 1 shows, schematically as a section representation, a possible embodiment of a compressor 10 according to the invention. The compressor 10, which in the described embodiment is designed as a semi-hermetic compact screw compressor and is intended to be used with NH₃ as coolant, has an electric motor 12 which drives a drive shaft 14. The drive shaft 14 drives a compressor unit 16 for compressing the coolant (NH₃).

The compressor 10 also has a coolant inlet 18 and a coolant outlet 20. In the embodiment described here, the coolant inlet 18 and the coolant outlet 20 are arranged such that incoming coolant flows through a motor space 22 of the compressor 10 in order to cool the electric motor 12, before it enters the compressor unit 16 where it is compressed to a final pressure and is then fed to the coolant outlet 20.

It is to be noted that, alternatively, it is also conceivable to cool the electric motor 12 using already-pressurized coolant, that is to say coolant which has already been compressed, by the compressor unit 16, to an intermediate pressure or a final pressure. In particular, in this context, reference is made to multi-stage compressors in which the motor is cooled using coolant at an intermediate pressure, i.e. coolant which has been compressed to an intermediate pressure by means of a first compression stage and which is used to cool the electric motor 12 before it is fed to a second compression stage.

In order to withstand the NH₃ used as coolant, the electric motor 12 has windings 24 which have a conductor 26 made of copper and an ammonia-resistant coating 28 arranged on the conductor 26 (see, for this, FIG. 2 and FIG. 3). In the embodiment described here, the coating consists of an extrudable material, i.e. a material which can be worked by means of an extrusion method. Other materials may also be used in alternative embodiments.

During production of the possible embodiment described here, both the conductor 26 and the coating 28 are extruded in two immediately successive extruding steps, which ensures rapid, economical and cost-effective production. Also conceivable, however, are alternatively two, in particular temporally separated extrusion processes, or also coating the conductor by means of another method, for example a spray method or a dipping method. Furthermore, other materials may be located between the conductor 26 and the coating 28, in particular materials provided in a layered arrangement. In the embodiment described, the coating has a thickness of a few hundred microns (μm).

Although the invention has been described with reference to embodiments with fixed feature combinations, it nonetheless also encompasses the conceivable further advantageous combinations as are indicated in particular, but not exhaustively, in the subclaims. All features disclosed in the application documents are claimed as essential to the invention insofar as they are novel over the prior art, whether individually or in combination.

### LIST OF REFERENCE SIGNS

10 compressor
12 electric motor
14 drive shaft
16 compressor unit
18 coolant inlet
20 coolant outlet
22 motor space
24 winding
26 conductor
28 coating

1. A compressor, in particular a semi-hermetic or hermetic displacement compressor, for compressing NH3, having an at least partially NH3-cooled electric motor with motor windings, wherein the motor windings comprise a conductor made of copper and an ammonia-resistant coating.

2. The compressor as claimed in claim 1, wherein the coating is made of an extrudable material.

3. The compressor as claimed in claim 1, wherein the coating is arranged directly on the conductor.

4. The compressor as claimed in claim 1, wherein the conductor and the ammonia-resistant coating are formed in two immediately successive extrusion steps, or in that the ammonia-resistant coating is sprayed on or is applied by means of a dipping method.

5. The compressor as claimed in claim 1, wherein the compressor is a semi-hermetic or hermetic NH3 compressor with intake gas cooling or intermediate pressure cooling, in particular a semi-hermetic or hermetic screw compressor, a semi-hermetic or hermetic compact screw compressor, a semi-hermetic or hermetic single-stage or two-stage piston compressor.

6. A method for producing a compressor, in particular a semi-hermetic or hermetic displacement compressor, for compressing NH3, comprising an at least partially NH3-cooled electric motor with motor windings, wherein the method comprises a step of producing the motor windings, wherein the step of producing the motor windings comprises the following sub-steps:
manufacturing a conductor from the material copper; and
coating the conductor with a coating made of an ammonia-resistant material.

7. The method as claimed in claim 6, wherein the conductor and/or the ammonia-resistant coating are produced by means of an extrusion method.

8. The method as claimed in claim 6, wherein the conductor and the ammonia-resistant coating are formed in two immediately successive extrusion steps, or in that the ammonia-resistant coating is sprayed on or is applied by means of a dipping method.

9. The use of motor windings, having a conductor made of copper and an ammonia-resistant coating, for the production of an electric motor of a displacement compressor, in particular a semi-hermetic or hermetic compressor, for compressing NH3, having an at least partially NH3-cooled electric motor with motor windings.

10. The use as claimed in claim 9, wherein the conductor and the ammonia-resistant coating are formed in two immediately successive extrusion steps, or in that the ammonia-resistant coating is sprayed on or is applied by means of a dipping method.
